(19) United States
(12) Patent Application Publication
(10) Pub. No.: US 2011/0017237 A1
(43) Pub. Date: Jan. 27, 2011

(54) FLUID EXTRACTING DEVICES AND ASSOCIATED METHODS OF USE AND MANUFACTURE

(76) Inventors: Kevin A. Wolfe, Burlington, WA (US); Brett Bartholmey, Bellingham, WA (US)

Correspondence Address: PERKINS COIE LLP;PATENT-SEA, P.O. BOX 1247, SEATTLE, WA, 98111-1247, US

(21) Appl. No.: 12/820,903

(22) Filed: Jun. 22, 2010

Related U.S. Application Data
(60) Provisional application No. 61/227,151, filed on Jul. 21, 2009.

(51) Int. Cl. A47L 9/02; B08B 5/04

(52) U.S. Cl. 134/21; 15/415.1

(57) ABSTRACT

Systems, devices, and methods for extracting fluid from a surface are disclosed. An extractor in accordance with a particular embodiment includes a first plate having a suction port positioned to be coupled to a vacuum source, and a second plate coupled to the first plate with a suction cavity therebetween. The second plate includes an exterior surface multiple projections extending therefrom. The exterior surface also includes multiple openings in fluid communication with the suction cavity. The individual openings are positioned between corresponding projections.

### CROSS-REFERENCE TO RELATED APPLICATION

The present application claims priority to U.S. Provisional Application No. 61/227,151, filed Jul. 21, 2009, and incorporated herein by reference.

### TECHNICAL FIELD

The following disclosure relates generally to devices and methods for extracting fluid from flooring such as carpeting.

### BACKGROUND

Vacuums sources or pumps are frequently used to remove water or other fluids from flooring such as carpeting. For example, vacuums are often used to extract water from carpeting in homes and buildings that have been flooded due to heavy rains, a broken pipe, sprinklers that are activated in response to a fire, etc. Vacuums are also used to extract water from carpeting that has been saturated with water or cleaning solutions to clean the carpeting. Removing as much water or fluid as possible from the carpeting helps the carpeting dry and prevents mold, unpleasant odors, and/or other undesirable consequences from wet carpeting. To remove the fluid from carpeting and/or any padding beneath the carpeting, vacuum sources are typically connected to a vacuum line and nozzle to provide an interface with the carpeting.

### BRIEF DESCRIPTION OF THE DRAWINGS

FIG. 1A is an isometric top view and FIG. 1B is an isometric bottom view of an extractor configured in accordance with an embodiment of the disclosure.

FIG. 2A is an exploded isometric top view and FIG. 2B is an exploded isometric bottom view of an embodiment of the base of the extractor shown in FIGS. 1A and 1B.

FIG. 2C is a bottom plan view of the upper plate of the base shown in FIGS. 2A and 2B.

FIG. 2D is a top plan view and FIG. 2E is a bottom plan view of the lower plate of the base shown in FIGS. 2A and 2B.

FIG. 3 is a partial side cross-sectional view of the extractor taken substantially along the lines 3-3 of FIG. 1A.

FIG. 4A is a partial side cross-sectional view of an extractor configured in accordance with another embodiment of the disclosure.

FIG. 4B is a side cross-sectional view of the lower plate of the extractor of FIG. 4A.

FIG. 4C is a bottom plan view of the lower plate of the extractor of FIG. 4B.

FIGS. 5A-5E are a series of partial side cross-sectional views illustrating bottom surfaces of various extractors configured in accordance with further embodiments of the disclosure.

### DETAILED DESCRIPTION

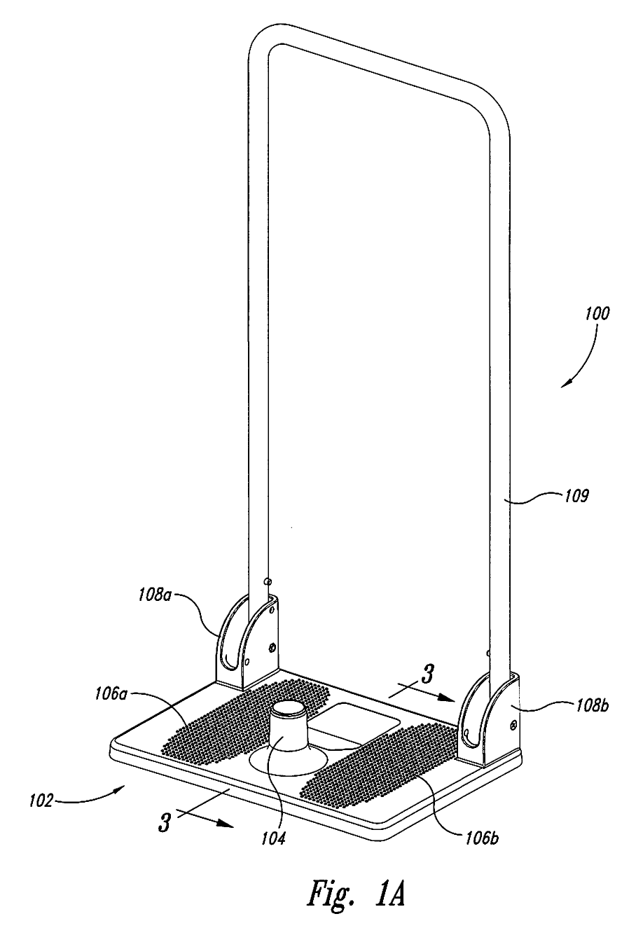

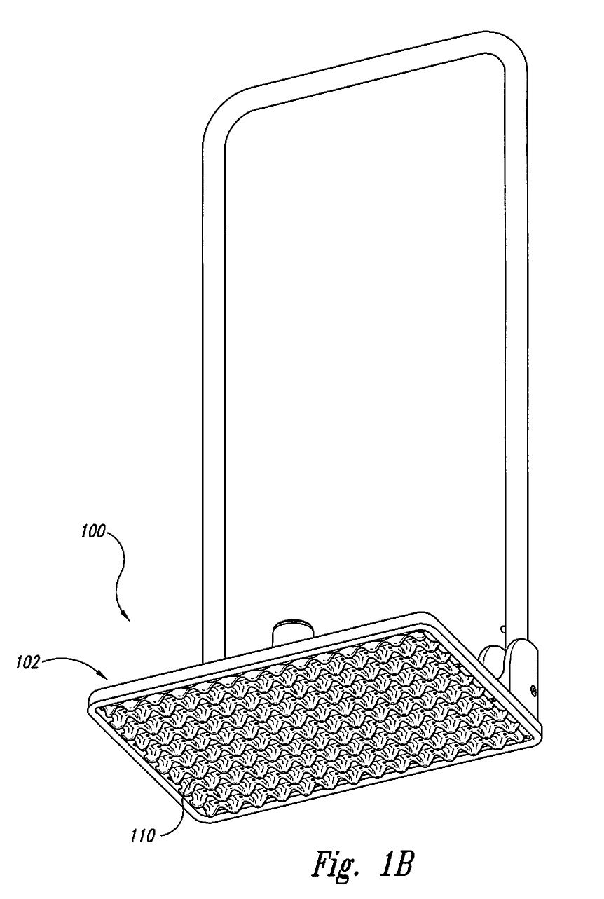

The present disclosure is directed generally to extractors and associated systems and methods for removing water or other fluids (e.g., liquids) from flooring, such as carpeting and padding beneath carpeting. Although embodiments included herein are described with reference to carpeting and/or padding, one of ordinary skill in the art will appreciate that the embodiments described herein can be used with various other types of flooring surfaces and materials. In addition, the following description identifies specific details with reference to FIGS. 1A-5E to provide a thorough understanding of various embodiments of the disclosure. Other details describing well-known structures or processes often associated with extractors, however, are not described below to avoid unnecessarily obscuring the description of the various embodiments of the disclosure. Moreover, although the following disclosure sets forth several embodiments of different aspects of the invention, other embodiments can have different configurations and/or different components than those described in this section. In addition, further embodiments of the disclosure may be practiced without several of the details described below, while still other embodiments of the disclosure may be practiced with additional details and/or features.

FIG. 1A is an isometric top view of an extractor 100 configured in accordance with an embodiment of the disclosure. In the illustrated embodiment, the extractor 100 includes a base 102 with a suction connector or port 104 that is configured to be coupled to a vacuum or suction source via a vacuum hose (not shown). The vacuum source can be a truck or van-based vacuum source, or any other type of suitable vacuum source to create suction through the base 102. The base 102 also includes textured regions 106 (identified individually in FIG. 1A as a first textured region 106a and a second textured region 106b) on either side of the suction port 104. The textured regions 106 provide a slip-free surface at the base 102 for a user to stand on during operation. The extractor 100 also includes a foldable handle 109 that extends from the base 102. The handle 109 is pivotally coupled to corresponding supports 108 (identified individually as a first support 108a and a second support 108b) and is a movable between a deployed position as shown in FIGS. 1A and 1B, and a stowed position folded adjacent to the base 102. In certain embodiments, the handle 109 can include locking mechanisms, such as spring loaded plungers that can extend into corresponding openings in the supports 108 to lock or otherwise secure the handle 109 in each of the deployed and stowed positions. In other embodiments, the supports 108 can include spring loaded plungers and the handle 109 can include corresponding openings. In still further embodiments, the handle 109 and supports 108 can include other suitable mechanisms for locking the handle 109 in the deployed and stowed positions, including, for example, removable hitch pins with corresponding locking cotter pins.

In the illustrated embodiment, the suction port 104 is located on the base 102 at a position that is spaced apart from the side of the base 102 with the supports 108. This location of the suction port 104 helps to at least partially keep the vacuum hose out of the way of the user's feet during use. In other embodiments, however, the suction port 104 can be positioned at different locations on the base 102, including for example, at a center portion of the base 102 or proximate to the side of the base 102 with the supports 108. In certain embodiments, the base 102 can be approximately 18 inches long by 12 inches wide. In other embodiments, however, the length and width of the base 102 can be greater than or less than 18 inches and 12 inches, respectively.

FIG. 1B is an isometric bottom view of the extractor 100. As shown in FIG. 1B and described in more detail below, the base 102 further includes a non-planar bottom surface 110. The bottom surface 110 includes a plurality of engaging features or projections extending therefrom that facilitate the fluid extraction from flooring surfaces, such as carpeting.

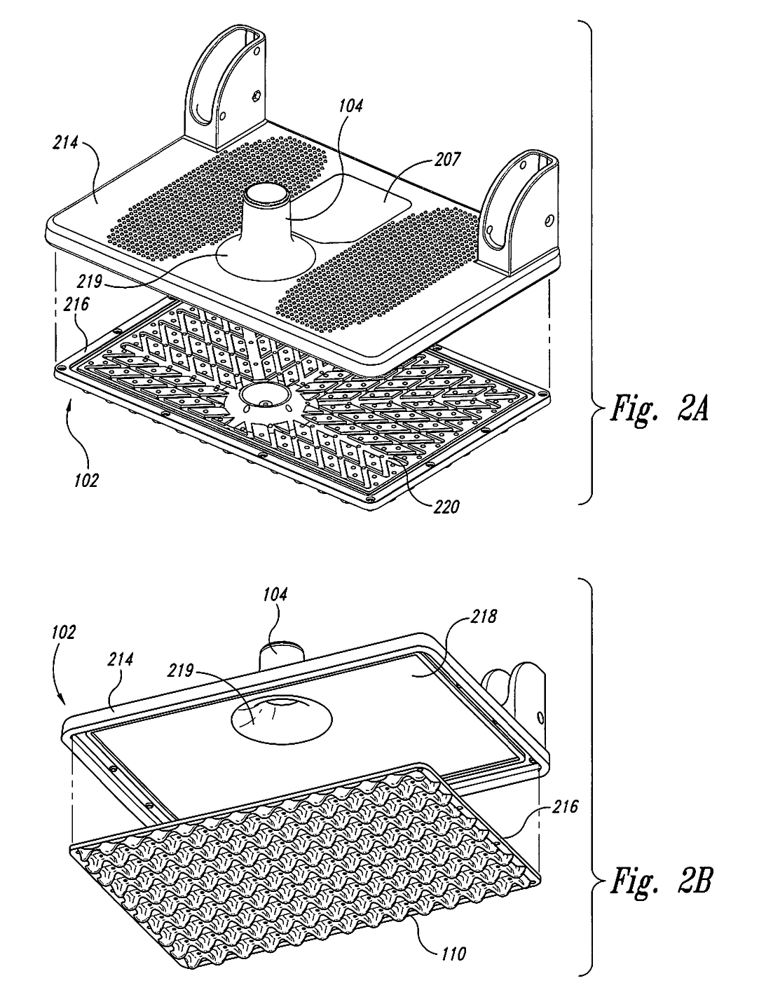

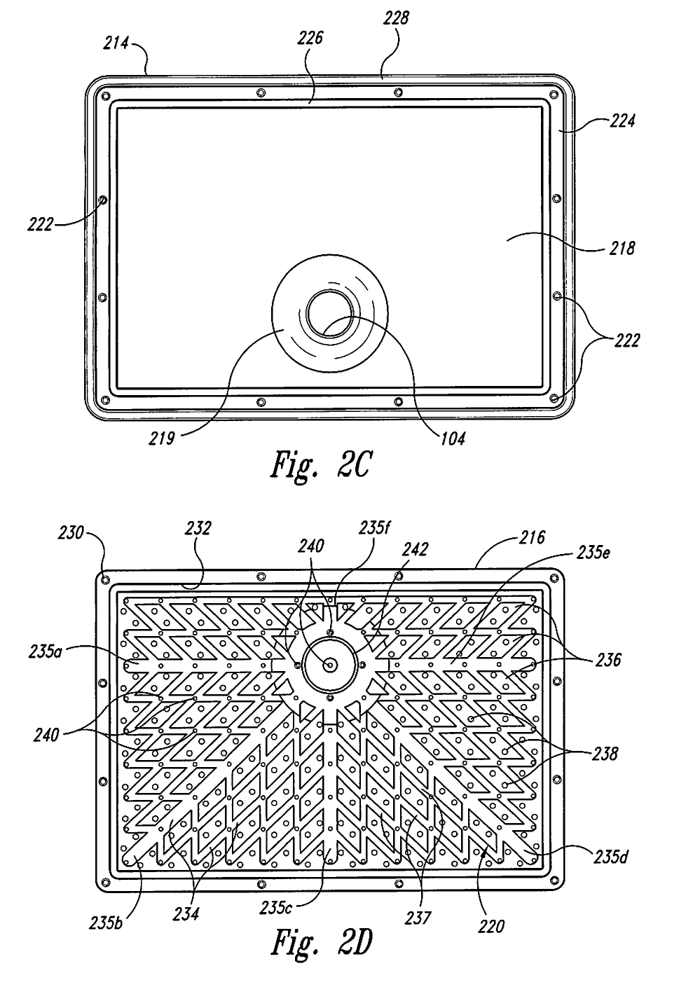

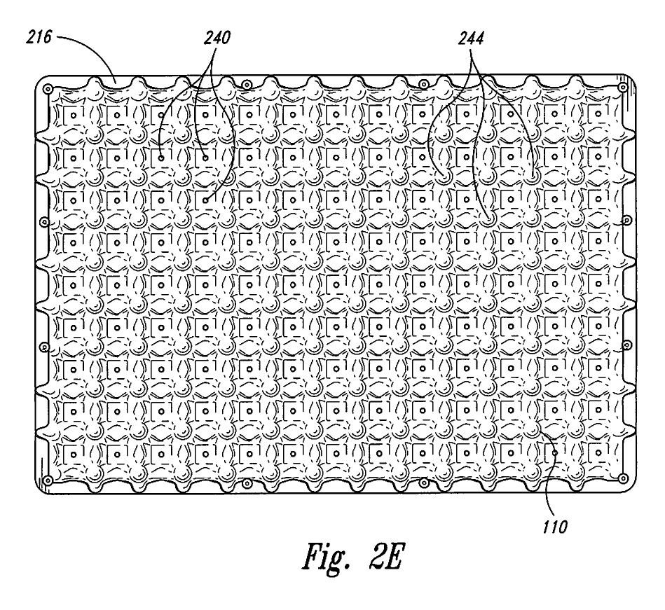

FIGS. 2A-3 illustrate several features of the base 102 in accordance with embodiments of the disclosure. More specifically, FIG. 2A is an exploded isometric top view and FIG. 2B is an exploded isometric bottom view of the base 102. Referring to FIGS. 2A and 2B together, the base 102 includes an upper plate 214 that is configured to be attached to a lower plate 216 to define a suction chamber or cavity therebetween. The upper plate 214 includes a first interior surface 218 (FIG. 2B) that faces an opposing second interior surface 220 (FIG. 2A) of the lower plate 216. In the illustrated embodiment, the first interior surface 218 is a generally flat or planar surface with the exception of a first flange 219 that transitions or connects the suction port 104 to the upper plate 214. In certain embodiments, the upper plate 214 and the lower plate 216 can each be made from plastic. More specifically, the upper plate 214 and the lower plate 216 can each be made from an injection molded plastic, including for example, a thermoplastic material and/or a thermoset material. In one embodiment, for example, the upper plate 214 can be made from polycarbonate, and the lower plate 216 can be made from acrylonitrile butadiene styrene (ABS). In still other embodiments, the upper plate 214, or at least a portion of the upper plate 214, can be transparent to allow a user to view or monitor fluid moving through the base 102 during use.

According to another feature of the illustrated embodiment, the upper plate 214 can also include a display area 207 (FIG. 2A) that can be configured to present information related to the extractor 100. For example, a sticker including a model number, company logo, or other information can be applied to the upper plate 214 at the display area 207. In other embodiments, information relating to the extractor 100 can be printed, embossed, stamped, or otherwise displayed at the display area 207, and/or at other areas of the upper plate 214.

Several more features of the upper plate 214 are shown in FIG. 2C, which is bottom plan view of the upper plate 214. As shown in FIG. 2C, the first flange 219 provides a transition to the suction port 104 from the planar first interior surface 218. The upper plate 214 also includes a plurality of first fastener openings 222 that are configured to receive corresponding fasteners (e.g., screws, bolts, rivets, etc.) to attach the upper plate 214 to the lower plate 216. The first fastener openings 222 are positioned in a channel 224 extending around the upper plate 214. The channel 224 is positioned between an inner lip 226 and an outer lip 220. The inner lip 226 is configured to create a seal around the attached lower plate 216. As described in detail below, the outer lip 228 is configured to at least partially seal the base 102 against the carpeting during use. In certain embodiments, the inner lip 226 and the outer lip 228 can made from deformable, semi-deformable, and/or rigid materials. In other embodiments, the inner lip 226 and the outer lip 228 can be integrally formed with the upper plate 214. In other embodiments, however, the inner lip 226 and/or the outer lip 228 can be separate pieces that are attached to the upper plate 214.

FIG. 2D is a top plan view of the lower plate 216 of the base 102 illustrating several features of the lower plate 216 and the second interior surface 220. For example, the lower plate 216 includes a plurality of second fastener openings 230 that correspond to the first fastener openings 222 of the upper plate 214 for attachment thereto. The illustrated lower plate 216 also includes a sealing channel 232 near the periphery of the lower plate 216. The sealing channel 232 is configured to receive the inner lip 226 of the upper plate 214 when the base 102 is assembled. The lower plate 216 also includes a second flange 242 that is positioned at a location that corresponds to the location of the first flange 219 of the upper plate 214. The second flange 219 extends upwardly to a rim portion and includes a central depression therein. Features of the second flange 242 are described in more detail below with reference to FIG. 3.

According to further features of the lower plate 216 illustrated in FIG. 2D, the second interior surface 220 includes multiple interconnected suction grooves or channels 234 extending between corresponding raised portions 236 of the lower plate 216. The interconnected channels 234 are configured to evenly distribute suction across the lower plate 216. The interconnected channels 234 include first suction channels 235 (identified individually as first through sixth first channels 235a-235f) and second suction channels 237 branching off the first channels 235. In the illustrated embodiment, the first channels 235 have a greater width than the second channels 237. In one embodiment, for example, each first channel 235 can have a width of approximately 0.5 inch, and each second channel 237 can have a width of approximately 0.3 inch. In other embodiments, however, the first channels 235 and the second channels 237 can have widths that are less than or greater than 0.5 inch and 0.3 inch, respectively. In still further embodiments, the first channels 235 and the second channels 237 can have the same width. In other embodiments, the first channels 235 can include greater than or less than six channels.

As also shown in the illustrated embodiment, the first channels 235 extend away from the second flange 242. For example, as shown in FIG. 2D, the first channels 235 form a generally star-shaped pattern extending away from the second flange 242, and the second channels 237 branch off of the corresponding first channels 235. These interconnected channels 234 form a symmetrical pattern that evenly distributes suction over the area of the lower plate 216. In other embodiments, the first channels 235 and the second channels 237 can form different patterns than that shown in FIG. 2D, including, for example, non-symmetrical or irregular patterns.

The lower plate 216 also includes multiple suction ports or openings 240 extending through the lower plate 216. The openings 240 are positioned in the interconnected channels 234 at the second interior surface 220 of the lower plate 216. The openings 240 are also positioned to extend through portions of the second flange 242.

As noted above, the suction channels 234 extend between raised portions 236 of the lower plate 216. In certain embodiments, each raised portion 236 can have a height of approximately 0.10 inch. In other embodiments, however, each raised portion can have a height that is less than or greater than 0.10 inch. In the illustrated embodiment, each raised portion 236 includes multiple protrusions or bumps 238 that are configured to contact the planar first interior surface 218 of the upper plate 214 when the upper plate 214 is attached to the lower plate 216. As explained in detail below, the raised portions 236 and corresponding bumps 238 form part of a continuous fluid evacuation surface from the lower plate 216 to the upper plate 214. In the illustrated embodiment, each raised portion 236 includes two bumps 238. In other embodiments, however, each raised portion 236 can include more than or less than two bumps 238. In certain embodiments each bump 238 can have a height of approximately 0.030-0.040 inch. In other embodiments, however, each bump can have a height that is less than 0.030 inch or greater than 0.040 inch. Although the illustrated bumps 238 have a generally hemispherical shape, in other embodiments the bumps 238 can have other shapes, including, for example, rectilinear, oblong, irregular, and/or other suitable shapes. As described in detail below, these features of the lower plate 216, in combination with the upper plate 214, facilitate the flow of water or other fluids through the base 102.

FIG. 2E is a bottom plan view of the lower plate 216 illustrating the non-planar bottom surface 110. As shown in FIG. 2E, the openings 240 exit the lower plate 214 between corresponding engaging features or projections 244. The projections 244 form an uneven or bumpy bottom surface 110 of the lower plate 214. As described in detail below with reference to FIG. 3, the projections 244 extend away from the bottom surface 110 and are configured to be at least partially embedded in the carpeting during use.

FIG. 3 is a partial side cross-sectional view of the extractor 100 taken substantially along the lines 3-3 of FIG. 1A. As shown in FIG. 3, a vacuum line or tube 350 is coupled to the suction port 104 to connect the extractor 100 to a vacuum source (not shown). With the lower plate 216 attached to the upper plate 214 as illustrated in FIG. 3, the second flange 242 is aligned with the suction port 104. As shown in the illustrated embodiment, the second flange 242 extends upwardly to a rim portion and includes a central depression. In certain embodiments, the bumps 238 of the lower plate 216 contact the first interior surface 218 of the upper plate 214 to create a suction chamber or cavity 343 between the first interior surface 218 of the upper plate 214 and the second interior surface 220 of the lower plate 216. FIG. 3 also shows the openings 240 extending through the lower plate 216, which are in fluid communication with the suction cavity 343. The openings 240 are tapered so as to be a smaller at the bottom surface 110 than at the second interior surface 220 of the lower plate 216. The tapered shape of the openings 240 can provide the benefit of at least partially preventing debris from clogging or blocking the openings 240 during use. In other embodiments, however, the openings 240 can be tapered so as to be smaller at the second interior surface 220 than at the bottom surface 110, or the openings 240 can have a generally constant cross-sectional dimension extending through the lower plate 216.

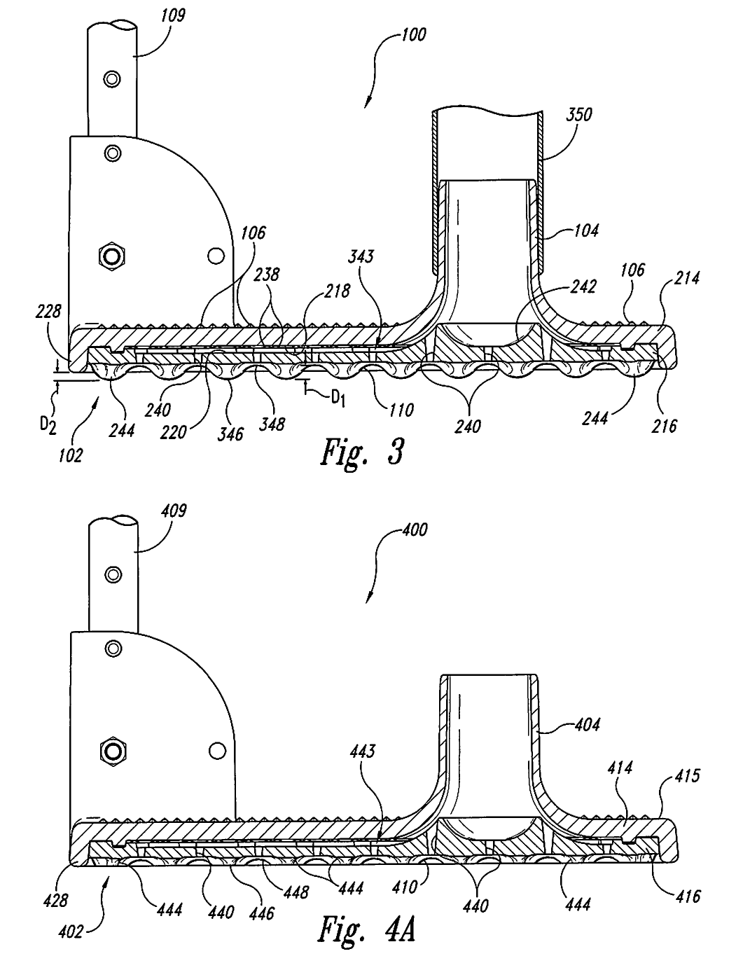

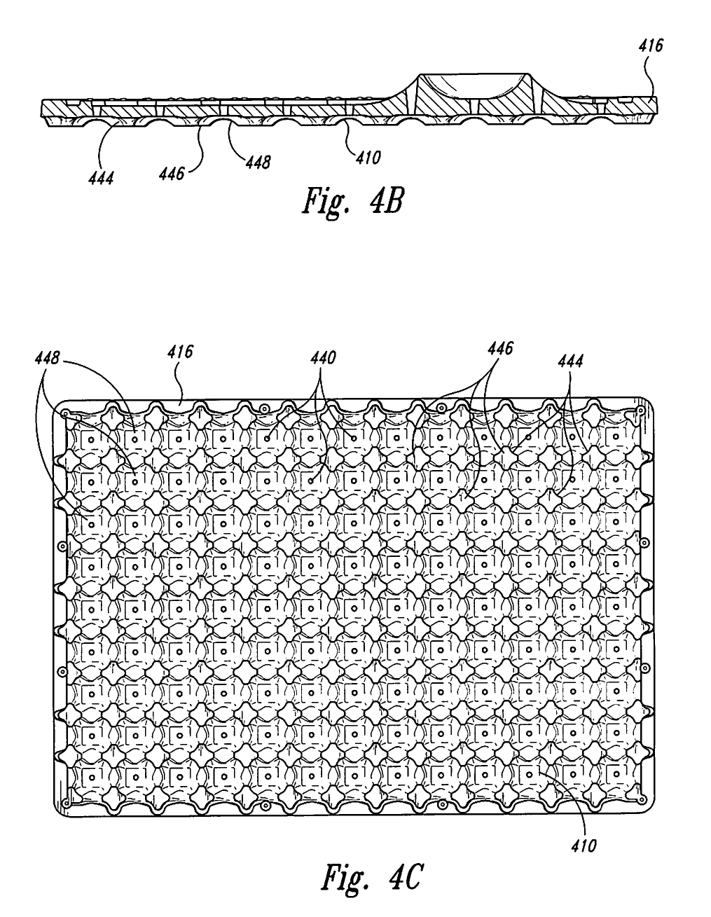

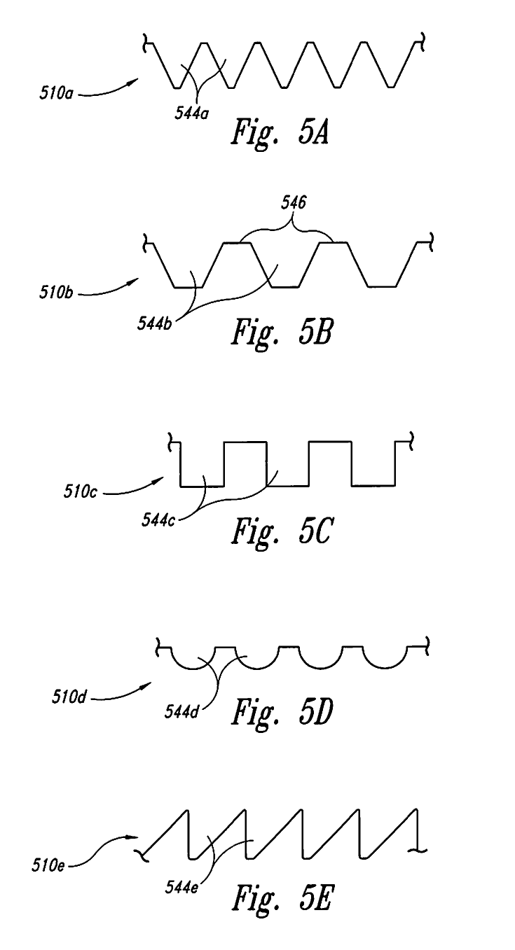

According to yet another feature of the embodiment illustrated in FIG. 3, the projections 244 extending away from the bottom surface 110 form a pattern having a generally wavy or undulating shape. More specifically, the cross-section of the projections 244 has a sine wave shape with a series of crests 346 and corresponding troughs 348 in the bottom surface 110. In other embodiments, however, and as described below with reference to FIGS. 4A-5E, the projections 244 can have other cross-sectional shapes and/or configurations. In the embodiment illustrated in FIG. 3, a first distance D₁ from crest 346 to trough 348 of the projections 244 can be approximately 0.35 inch. In other embodiments, however, the first distance D₁ can be less than or greater than 0.35 inch. In certain embodiments a second distance D₂ from a plane defined by the crests 346 to the lower surface of the outer lip 228 of the upper plate 214 can be approximately 0.188 inch. In other embodiments, however, the second distance D₂ can be less than or greater than 0.188 inch.

In operation, a user can position the extractor 100 at a desired location on carpeting and stand on the base 102 at the textured regions 106 of the upper plate 214. A vacuum source coupled to the suction port 104 via the vacuum line 350 creates suction through the base 102, and the weight of the user pushes the projections 244 into the carpeting. The weight of the user can also cause the outer lip 228 of the upper plate 214 to contact the carpeting to at least partially seal the outer periphery of the base 102 to the carpeting. As the projections 244 are pressed into the carpeting, the projections 244 compress the fluid out of the carpeting and/or padding beneath the carpeting. The suction in the base 102 draws this fluid through the openings 240 to remove the fluid from the carpeting. When the extractor 100 is removing a relatively large quantity of fluid from the carpeting, the fluid flows through the openings 240 and the interconnect channels 234 (FIG. 2D), and exits the base 102 via the suction port 104. As the extractor 100 dries the carpeting, however, such that the extractor 100 draws a relatively smaller quantity of fluid from the carpeting, this fluid can travel along the surfaces of the various features of the second interior surface 220 and the first interior surface 218 to the suction port 104 that form a continuous water evacuation path or surface. More specifically, the fluid can travel into the base 102 through the openings 240 in the lower plate 216 and along the channels 234 (FIG. 2D) in the lower plate 216. From these channels 234, the fluid travels along the raised portions 236 and corresponding bumps 238 (FIG. 2D) to the planar first interior surface 218 of the upper plate 214. At the first interior surface 218, the fluid is suspended from the first interior surface 218 and travels towards the suction port 104 and is drawn into the vacuum line 350 and out of the base 102.

According to one feature of the illustrated embodiment, the second flange 242 at least partially eliminates a “dead spot” in the suction area beneath the suction port 104. For example, without the second flange 242 present in the base 102, the force of the suction in the base 102 may form a vortex or eddy beneath the suction port 104 such that a portion of the fluid that is drawn into the base 102 may continually spin in a whirlpool pattern beneath the suction port 104. This whirlpool effect can prevent at least a portion of the fluid drawn into the base 102 from exiting the base 102 via the suction port 104. The second flange 242, however, eliminates or at least reduces this problem by maintaining the velocity of the fluid flow and at least partially lifting the fluid into the air stream that is drawn into the suction port 104 and the vacuum line 350.

In embodiments where the upper plate 216 is transparent, the user is able to view the fluid moving through the base 102 as the extractor 100 removes from the fluid from the carpeting. The transparent upper plate 216 accordingly allows the user to visually determine when the extractor 100 is no longer removing fluid from the carpeting so that the user knows when to move the extractor to a new position. In other embodiments, the user can stand on the base 102 for a predetermined amount of time (e.g., 5-10 seconds, or more) before moving the extractor to the next location. In either case, when the carpeting is sufficiently dry the user can step off of the extractor 100 and tilt the base 102 via the handles 109 to break the seal or suction with the carpeting. The user can then move the extractor 100 to the next desired position and continue the process of removing fluid from the carpeting.

FIG. 4A is a partial side cross-sectional view of an extractor 400 configured in accordance with another embodiment of the disclosure. The extractor 400 includes several features that are generally similar in structure and function to the corresponding features of the extractor 100 described above with reference to FIGS. 1A-3. For example, the extractor 400 illustrated in FIG. 4A includes a handle 409 extending from a base 402. The base 402 includes an upper plate 414 that is configured to be attached to a lower plate 416 to define a suction cavity 443 therebetween. The upper plate 414 includes a suction port or connector 404 that is configured to be coupled to a vacuum source via a vacuum hose (not shown). The lower plate 416 includes multiple suction ports or openings 440 extending through the lower plate 416. The openings 440 exit the lower plate 414 between corresponding engaging features or projections 444 extending from a bottom surface 410 of the lower plate 414. As described in detail below, the projections 444 form an uneven or bumpy bottom surface 410 of the lower plate 414.

According to one feature of the embodiment illustrated in FIG. 4A, each of the projections 444 has a generally flat surface or planar portion 446 spaced apart from the bottom surface 410. More specifically, each projection 444 has curved side portions extending from the bottom surface 410 to the generally flat portion 446, thereby defining a plateau-like shape for each projection 444. The flat portion 446 of each projection 444 is accordingly positioned between corresponding troughs or curved pockets or low spots 448 in the bottom surface 410. In the illustrated embodiment the flat portions 446 of the collective projections 444 are generally coplanar with one another, as well as generally parallel with the exterior surface 415 of the upper plate 414. As such, the flat portions 446 are configured to be generally parallel with the flooring surface when the extractor is positioned on the flooring surface. In other embodiments, however, the flat portions 446 can be positioned in more than one plane.

FIG. 4B is a side cross-sectional view of the lower plate 416 of the extractor 400 of FIG. 4A. As shown in FIG. 4B, the projections 444 extending away from the bottom surface 410 form a pattern having a generally wavy or undulating shape. More specifically, the cross-section of the projections 444 has a truncated sine wave shape with a series of the flat portions 446 and corresponding troughs 448 in the bottom surface 410. In other embodiments, however, and as described below with reference to FIGS. 5A-5E, the projections 444 can have other cross-sectional shapes and/or configurations. In the embodiment illustrated in FIGS. 4A and 4B, the flat portions 446 of the corresponding projections 444 are generally coplanar with the lower surface of an outer lip 428 of the upper plate 414 (FIG. 4A). In other embodiments, however, the flat portions 446 can extend beyond the lower surface of the outer lip 428, or be recessed relative to the lower surface of the outer lip 428.

FIG. 4C is a bottom plan view of the lower plate 416 of FIG. 4B illustrating the bottom surface 410. As shown in the illustrated embodiment, each of the flat portions or surfaces 446 of the corresponding projections 444 has a generally four prong clover or star shape. As also shown in FIG. 4C, the suction ports or openings 440 exit the lower plate 414 between corresponding projections 444. More specifically, the openings 440 exit the lower plate 416 in the troughs or low spots 448 between the corresponding projections 444.

FIGS. 5A-5E are a series of partial cross-sectional side views illustrating first through fifth bottom surfaces 510a-510e, respectively, of various extractors configured in accordance with further embodiments of the disclosure. Many aspects of the extractors and corresponding bottom surfaces 510a-510e can be at least generally similar in structure and function to corresponding aspects and features of the extractor 100 and bottom surface 110 described above with reference to FIGS. 1A-3. The bottom surfaces 510a-510e of FIGS. 5A-5E, however, include different shaped protrusions that are encompassed by the present disclosure. In FIG. 5A, for example, the first bottom surface 510a includes a series of first protrusions 544a having triangular shapes forming a triangular wave pattern. Referring next to FIG. 5B, the second bottom surface 510b includes a series of second projections 544b having a trapezoidal or truncated triangular shapes with planar segments 546 extending between corresponding second projections 544b. In FIG. 5C, the third bottom surface 510c includes a series of third projections 544c having a square or rectangular shapes forming a square wave pattern. Turning next to FIG. 5D, the fourth bottom surface 510d includes a series of fourth projections 544d having a generally semicircular shapes. In FIG. 5E, the fifth bottom surface 510e includes a series of fifth projections 544e having generally right-angle triangular shapes forming a saw tooth wave pattern.

Although the embodiments illustrated in FIGS. 5A-5E illustrate several different shaped projections and patterns of bottom surfaces of extractors configured in accordance with the present disclosure, in still other embodiments extractors can have bottom surfaces having different shaped projections and/or patterns than those shown in the Figures. For example, a bottom surface according to the present disclosure can include protrusions having symmetrical, asymmetrical, regular, irregular, rectilinear, undulating, wavy, dimpled, egg carton-like, and/or any other non-planar shape. In other embodiments, protrusions of different sizes can be included on the same bottom surface.

From the foregoing, it will be appreciated that specific embodiments have been described herein for purposes of illustration, but that various modifications may be made without deviating from the disclosure. For example, an extractor as described herein can have a bottom surface with a generally planar region at least partially surrounded by projections extending from the bottom surface. In addition, an extractor as described herein can be configured so that a user can operate the extractor without standing on the extractor during operation. In other embodiments, an extractor can include retractable wheels or wheels that contact a flooring surface when the extractor is partially angled or tipped over to allow a user to easily move the extractor to different locations. In still further embodiments, an extractor can include multiple suction ports to facilitate connection to a vacuum source. Aspects described in the context of particular embodiments may be combined or eliminated in other embodiments. For example, an extractor configured in accordance with one embodiment of the disclosure may include a single piece or integral base with a bottom surface having projections extending therefrom with corresponding planar surfaces. Further, although advantages associated with certain embodiments have been described in the context of those embodiments, other embodiments may also exhibit such advantages, and not all embodiments need necessarily exhibit such advantages to fall within the scope of the disclosure. Accordingly, the disclosure and associated technology can encompass other embodiments not expressly shown or described herein.

I/We claim:

1. An extractor for removing fluid from a flooring surface, the extractor comprising:
a first plate having a suction port positioned to be coupled to a vacuum source; and
a second plate coupled to the first plate with a suction cavity therebetween, the second plate having an exterior surface multiple projections extending therefrom, the exterior surface further comprising multiple openings in fluid communication with the suction cavity, wherein the individual openings are positioned between corresponding projections.

2. The extractor of claim 1 wherein individual projections have a generally planar surface.

3. The extractor of claim 2 wherein the planar surfaces of individual projections are generally coplanar with one another.

4. The extractor of claim 2 wherein the planar surfaces of individual projections are positioned to contact the flooring surface and be generally parallel with the flooring surface when the extractor is positioned on the flooring surface.

5. The extractor of claim 1 wherein individual openings have a tapered cross-sectional dimension along an axis extending through the second plate.

6. The extractor of claim 5 wherein the tapered cross-sectional dimension of individual openings is smallest proximate to the exterior surface.

7. The extractor of claim 1 wherein:
the first plate includes a first interior surface that is generally planar; and
the second plate includes a second interior surface opposite the first interior surface, the first and second interior surfaces defining at least in part the suction cavity, wherein the second interior surface includes a plurality of channels extending between corresponding raised portions, and wherein individual raised portions extend towards the first interior surface.

8. The extractor of claim 7 wherein individual raised portions include one or more corresponding protrusions contacting the first interior surface of the upper plate.

9. The extractor of claim 7 wherein the plurality of channels comprise first channels each having a first width, and wherein the second interior surface further comprises a plurality of second channels each having a second width less that the first width.

10. The extractor of claim 9 wherein the first and second channels are interconnected.

11. The extractor of claim 7 wherein second plate further comprises a flange extending from the second interior surface and generally aligned with the suction port of the first plate.

12. The extractor of claim 1 wherein the exterior surface is a first exterior surface and wherein the first plate includes a second exterior surface opposite the first exterior surface, the second exterior surface including at least one textured region.

13. An extractor for extracting fluid from a surface, the extractor comprising:
a base portion having a suction chamber, the base portion further having a first exterior surface opposite a second exterior surface, the second exterior surface having a plurality of suction ports extending through a portion of the base to the suction chamber, the second exterior surface further having a plurality of engaging features projecting therefrom; and
a connector at the first exterior surface positioned to be coupled to a suction source.

14. The extractor of claim 13 wherein the base portion further comprises a first plate coupled to a second plate, and wherein:
the first exterior surface is an exterior surface of the first plate, the first plate further having a generally planar first interior surface; and
the second exterior surface is an exterior surface of the second plate, the second plate further having a generally non-planar second interior surface opposite the first interior surface, the first and second interior surfaces defining at least in part the suction cavity.

15. The extractor of claim 14 wherein at least a portion of the first plate is transparent.

16. The extractor of claim 13 wherein individual engaging features have a generally planar portion.

17. The extractor of claim 16 wherein the second exterior surface further comprises curved surface portions extending between corresponding planar portions of the engaging features.

18. The extractor of claim 16 wherein individual planar portions of the engaging features are generally parallel with the first exterior surface.

19. The extractor of claim 16 wherein the base portion further comprises an outer lip at least partially surrounding a peripheral portion of the second exterior surface, and wherein at least one of the planar portions is generally coplanar with a lower portion of the outer lip.

20. The extractor of claim 13 wherein the suction ports exit the second exterior surface between the corresponding engaging features.

21. The extractor of claim 13, further comprising a handle pivotally coupled to the base portion.

22. An extractor for removing fluid from a flooring surface, the extractor comprising:
a first base portion;
a second base portion coupled to the first base portion, the second base portion having a non-planar exterior surface, the exterior surface having means for at least partially compressing the flooring surface;
a suction cavity between the first base portion and the second base portion;
means for introducing the fluid into the suction cavity through the second base portion from the flooring surface; and
means for removing the fluid from the suction cavity through the first base portion.

23. The extractor of claim 22 wherein the means for at least partially compressing the flooring surface comprises a plurality of protrusions extending away from the exterior surface of the second base portion.

24. The extractor of claim 23 wherein the individual protrusions have a generally planar surface positioned to be generally parallel with the flooring surface when the engaging features compress the flooring surface.

25. The extractor of claim 22 wherein the means for introducing the fluid into the cavity comprises multiple openings in the exterior surface of the second base portion in fluid communication with the cavity.

26. The extractor of claim 22 wherein the means for removing the fluid from the suction cavity comprises a suction port extending from the first base portion.

27. A method of removing fluid from a flooring surface, the method comprising:
positioning a fluid extractor on the flooring surface, the fluid extractor comprising a base portion with an exterior surface having a plurality of projections extending therefrom, the exterior surface further having a plurality of openings in fluid communication with a suction cavity in the base;
coupling the fluid extractor to a vacuum source;
at least partially compressing the flooring surface with individual projections of the exterior surface;
extracting fluid from the flooring surface through the openings in the exterior surface into the suction cavity; and
removing the fluid from the suction cavity.

28. The method of claim 27 wherein:
at least partially compressing the flooring surface comprises at least partially pressing the individual projection into the flooring surface; and
extracting fluid from the flooring surface comprises extracting fluid from portions of the flooring surface positioned between corresponding projections.

29. The method of claim 27 wherein positioning the fluid extractor comprises positioning the fluid extractor at a first location on the flooring surface, the method further comprising repositioning the extractor at a second location on the flooring surface and at least partially compressing the flooring surface at the second location with individual projections.

30. The method of claim 27 wherein at least partially compressing the flooring surface comprises applying additional weight to the base portion of the extractor.

31. The method of claim 27 wherein at least partially compressing the flooring surface comprises at least partially sealing an outer peripheral edge portion of the base against the flooring surface.

32. The method of claim 27 wherein at least a portion of the base is transparent, and wherein the method further comprises monitoring at least a portion of the fluid in the suction cavity.

33. The method of claim 27 wherein removing fluid from the suction cavity comprises removing fluid from the suction cavity along a continuous fluid evacuation surface of the base portion.

34. The method of claim 27 wherein extracting fluid from the flooring surface comprises extracting fluid from the flooring surface while the extractor is generally stationary.
